(19) United States
(12) Patent Application Publication
(10) Pub. No.: US 2008/0126414 A1
(43) Pub. Date: May 29, 2008

(54) METHOD, SYSTEM, AND COMPUTER PROGRAM PRODUCT FOR PROVIDING A PROGRAM INTERFACE FOR COMMUNICATIONS BETWEEN A MANUFACTURING EXECUTION SYSTEM AND A TRANSPORT SYSTEM

(75) Inventor: Rakesh K. Parimi, New Windsor, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/563,382

(22) Filed: Nov. 27, 2006

(51) Int. Cl. G06F 17/30; G06F 17/00

(52) U.S. Cl. 707/104.1; 700/110; 707/E17.008

(57) ABSTRACT

A method, system, and computer program product for providing a program interface for communications between a manufacturing execution system (MES) and a transport system are provided. The method includes initiating a communication with the transport system, querying the transport system for a list of active transport jobs, and inspecting a response to the querying and identifying carriers for notifying the MES of load complete and unload complete requests. The method also includes notifying the MES that identified carriers are ready for respective load and unload complete actions. Upon determining a malfunction occurrence between the MES and the transport system, the method includes using results of the querying and inspecting to provide a status of the active transport jobs, and deleting carrier IDs for the identified carriers from the list of active transport jobs in response to the notifying.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to automated material handling systems, and particularly to a method, system, and computer program product for providing a program interface for communications between a manufacturing execution system and a transport system.

2. Description of Background

Before our invention, there was no means for directly interfacing with a manufacturing automation application for the purpose of detecting various activities, e.g., when transport activities have been completed, when transport activities have created an error, or identifying the state of a transport activity with respect to a manufacturing control and execution system (MES).

Without being able to interface with automation applications (except perhaps directly by the MES), there is no way to perform disaster recovery in real time when the MES interface with the automated applications malfunctions. This may cause serious issues, as such malfunctions are known to occur quite frequently in a manufacturing environment. For example, each malfunction can result in a recovery time of, on average, five hours, thereby resulting in significant losses of manufacturing time.

In addition, there is currently little or no means for directly interfacing with a simulated automation system, as most MES systems do not adequately, if at all, provide this capability. An automated application simulator is typically used with non-production MES systems for the purpose of testing, debugging, providing process improvements, etc. Some MES systems include a weak link into an automated simulator, e.g., simulating some E84 activities, however they do not provide a way to detect the state of the simulator. Being able to keep track of each E84 activity can be critical when using an application such as manufacturing automation control system (MACS) simulator for providing realistic E84 activities with events into the MES, creating realistic automated material handling system (AMHS) and/or automated reticle handling system (ARHS) events, detecting the current health of MACS simulator, inducing autonomic recovery (e.g., disaster recovery), etc.

What is needed, therefore, is a way to directly interface (e.g., without going through an MES) with a manufacturing automation application for the purpose of detecting various activities, such as when transport activities have been completed, when transport activities have created an error, or identifying the state of a transport activity with respect to a manufacturing control and execution system (MES).

### SUMMARY OF THE INVENTION

The shortcomings of the prior art are overcome and additional advantages are provided through the provision of a method, system, and computer program product for providing a program interface for communications between a manufacturing execution system (MES) and a transport system. The method includes initiating a communication with the transport system, querying the transport system for a list of active transport jobs, and inspecting a response to the querying and identifying carriers for notifying the MES of load complete and unload complete requests. The method also includes notifying the MES that identified carriers are ready for respective load and unload complete actions. Upon determining a malfunction occurrence between the MES and the transport system, the method includes using results of the querying and inspecting to provide a status of the active transport jobs, and deleting carrier IDs for the identified carriers from the list of active transport jobs in response to the notifying.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which directly interfaces with a manufacturing automation application or simulator that is used to detect various activities including, e.g., when transport activities have been completed, when transport activities have created an error, or identifying the state of a transport activity with respect to a manufacturing control and execution system (MES).

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which E84 interface activities may be implemented in exemplary embodiments; and

FIG. 2 illustrates one example of a method for implementing the E84 interface activities in exemplary embodiments.

The detailed description explains the preferred embodiments of the invention, together with advantages and features, by way of example with reference to the drawings.

### DETAILED DESCRIPTION OF THE INVENTION

The efficiency of a manufacturing enterprise depends, in part, on the quick flow of information and process execution across a complete supply chain. Advancements in shop-floor activities include the automation of production equipment, material processing, material control systems, and the integration of these systems with a host manufacturing execution system (MES). Automating manufacturing processes for certain industries presents many challenges. Unlike the automotive industry, for example, which employs standard assembly-line processing techniques, the manufacture of semiconductor materials such as wafers in an electronics industry generally involves non-linear processing techniques and frequent changes to production tools that are introduced to the AMHS.

Moreover, due to the migration of larger and heavier wafers (e.g., 300 mm), manufacturers are relying more heavily on AMHSs to handle the processing and inter-bay transport of these items. Recent advancements in AMHS technology include the standardization of control signals that are transferred between production equipment and the AMHS, as well as the associated cabling requirements. This standardization ensures reliability in loading and unloading wafer materials at the production equipment load ports and is defined by Semiconductor Equipment and Materials International® (SEMI), headquartered in San Jose, Calif., in publication “SEMI E15.1-1108 Specification for 300 mm Tool Load Port” and is also referred to as SEMI E84 standard.

The MES typically includes an interface that transmits and receives signals between itself and the AMHS (or AMHS simulator), which controls the operation of the automated production equipment. Oftentimes, the MES interface to the AMHS/AMHS simulator malfunctions during operations, which results in a manual recovery process that includes discontinuing production for a period of time.

The E84 interface and related activities described herein provide a direct connection to the AMHS, or automated applications (or alternatively, AMHS simulator) as described herein. Thus, when a malfunction occurs with respect to the MES interface, the E84 interface ensures that recovery activities may be implemented without disruption to the production environment.

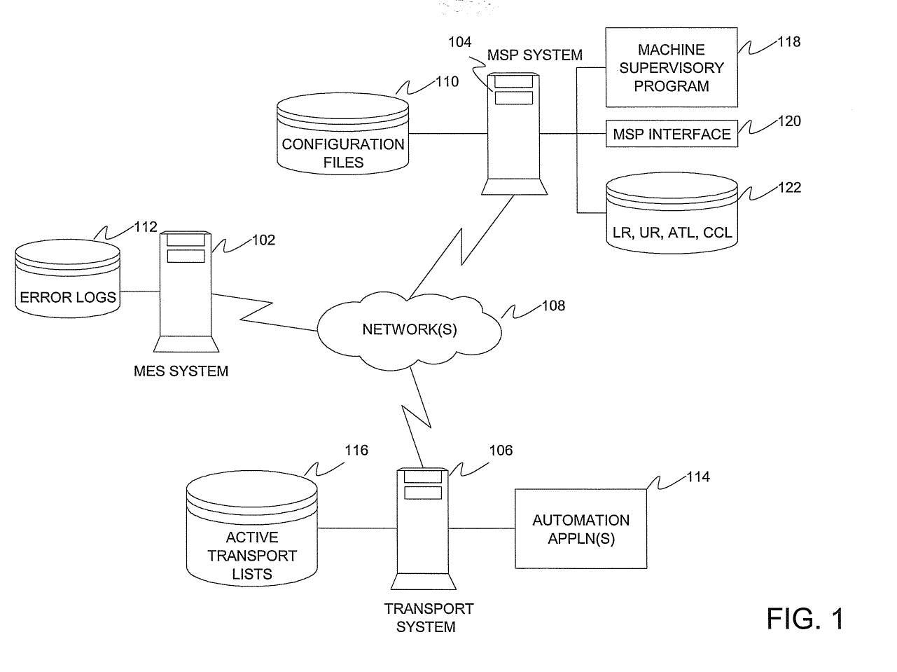

Turning now to the drawings in greater detail, it will be seen that in FIG. 1 there is a system upon which E84 interface activities may be implemented in accordance with exemplary embodiments.

The system of FIG. 1 includes an MES system 102, a machine supervisory system (MSP) 104, and a transport system 106, each of which is in communication over one or more networks 108. For purposes of illustration, the system of FIG. 1 is a semiconductor fabrication plant in which 300 mm wafers are processed.

MES system 102 may be implemented by a server that executes various manufacturing-related applications such as a manufacturing execution system application, a dispatcher, and a scheduling application. Manufacturing execution system 102 manages the operations conducted within the system of FIG. 1. MES system 102 is in communication with a storage device 112 that stores, e.g., error logs generated and used by the E84 interface activities described herein. MES system 102 is in communication with transport system 106, a machine supervisory program (MSP) system 104, and process equipment (not shown) via networks 108. Networks 108 may comprise any type of communications network. In preferred embodiments, networks 108 include an Ethernet local area network (LAN).

MSP system 104 executes a machine supervisory program (MSP) application 118 that communicates with process equipment and controls messaging and job processing on the process equipment. Machine supervisory program 118 may be a simulator (e.g., a program that mimics a machine supervisory program to outside applications (e.g., the MES application)); however, as a simulator, it does not communicate with the process equipment. The MSP 118 generates lists for maintaining various activities. For example, the MSP 118 generates a list to maintain active transport jobs (ATL), active LOAD requests (LR), active UNLOAD requests (UR), and active simulator (e.g., MSP/equipment) to client connection information for use in transmitting messages back to the simulator (e.g., MSP/equipment). This list is referred to herein as “CCL”. An example incoming LOAD request may include Carrier ID, Load port ID, Tool ID, and the LOAD request associated with corresponding process equipment. This information may be stored in storage device 122.

The MSP system 104 further executes a machine supervisory program (MSP) interface 120 for facilitating the E84 interface activities described herein. MSP system 104 is in communication with storage devices 110 and 122. Storage device 110 stores configuration files and storage device 122 stores various other data including LOAD and UNLOAD request tables, as described herein.

Transport system 106 executes one or more automation applications 114 (e.g., an automated material handling system (AMHS) control application) that manage the transport of materials within a production area. Automated application 114 may be a material control system (MCS) application such as Murata's® Automated Material Handling Control System by Murata Machinery, Ltd.™ Automation application 114 receives operations and scheduling information for processing of materials on process equipment in the production area of the system of FIG. 1, via transport system 106. This information can be obtained from any suitable manufacturing execution system software utilized by the production system enterprise, e.g., applications executing on MES system 102.

Transport system 106 is in communication with a storage device 116. Storage device 116 may store a variety of information, e.g., transport process jobs and active transport lists. Transport process jobs refer to work orders or directives that instruct the automated application 114 to carry out specified operations with respect to process equipment in communication with the transport system 106. Automation application 114 may be responsible for coordinating the efforts of the transport system 106 to move materials to the appropriate location such as various process equipment in the production area. Automated application 114 may also function as an interface between the MES application and the process equipment.

The transport system 106 controls various AMHS/ARHS (automated reticle handling system) equipment. AMHS equipment may include active and passive equipment. For example, AMHS equipment may include, e.g., an overhead transport (OHT) device and a carrier. These are also referred to herein as ‘active’ equipment. It will be understood that other automated equipment may be utilized in addition to, or in lieu of, OHT device such as, for example, automated guided vehicles (AGVs), monorails, track vehicles, robotic devices, and other similar vehicles used to move materials. The carrier comprises a device used for holding substrates pending processing, such as wafers, dies, and integrated circuits. Also included in the AMHS equipment is a stocker. The stocker represents a unit for storing materials that are awaiting processing or are awaiting transport to another location and receives materials from the carrier.

In a typical E84 handshake operation, signals are exchanged between process equipment load ports and the AMHS equipment. These control signals relate to state changes which indicate initiation and execution of a handoff. A signal interface between active and passive components during the handshake may be implemented. For example, a signal interface defined by SEMI® E84 specification may be used. Timing requirements are also defined by SEMI® E84 specification. Timers provide timing of critical sections of load/unload sequences.

The process equipment may include a processing machine, which comprises a fabrication device used to process materials. Process equipment typically employ one or more load ports which enable the loading and unloading of production materials to and from a carrier. For example, in a semi-conductor manufacturing environment, load ports may be used to receive wafer carriers, frame carriers, and other similar items. Load ports are preferably SEMI-compliant (i.e., conform to standards set forth by Semiconductor Equipment and Materials International (SEMI), an organization with established goals to further industry improvement by bringing industry persons together to solve common technical issues). Thus, the initiation and execution of the loading and unloading processes are referred to herein as an E84 handoff or handshake.

As shown in FIG. 1, the systems 102, 104, and 106 may be implemented as separate, independent servers. Alternatively, one or more of the systems 102, 104, and 106 may be combined into a single server executing the processes described herein. It will be understood that storage devices 110, 112, 116, and 122 may be implemented using memory contained in the respective systems 102, 104, 106, or may be separate physical devices. Each of the storage devices 110, 112, 116, and 122 is logically addressable as a consolidated data source across a distributed environment that includes networks 108. Information stored in the storage devices may be retrieved and manipulated via the respective systems 102, 104, 106.

The features and functions of the E84 interface activities utilize standard protocols and may be written using Java, such that the solution may be operating system platform independent. The E84 interface activities are facilitated via the MSP interface application 120 using algorithms designed and implemented, e.g., in Java, and use customizable business logic interfaces (e.g., BPEL). The algorithms are implemented via the MSP interface application 120 and incorporate a specification for virtualization, which provides a technique for transforming a target environment farm (e.g., hardware-to-hardware and hardware-to-software interfaces and relationships in a production system) into a model that can be used by the MSP interface application 120. The target environment farm is converted into a model (referred to as a virtual target environment) that models these aforementioned interfaces and relationships.

For example, the rules for transforming may include replacing a hardware component with an equipment simulator component (e.g., an instance of the MSP interface application 120) when the hardware component is controlled by a software component and does not interface with any other hardware or software components. In addition, if a first hardware component is interfacing with a second hardware component such that only the first hardware component has a software control, then the first hardware component is replaced with an equipment simulator component, which is an instance of the MSP interface application 120. The second hardware component is replaced by an equipment simulator component, which is also an instance of the MSP interface application 120, interfacing with the equipment simulator for the first hardware component, to model the relationships.

While executing the transformation, the integrity of the interfaces between the software components is maintained, all hardware-to-hardware interfaces are eliminated with a minimized set of equipment simulator controls, and the integrity of all events generated by the target environment farm is maintained by providing appropriate inter-equipment simulator interfaces.

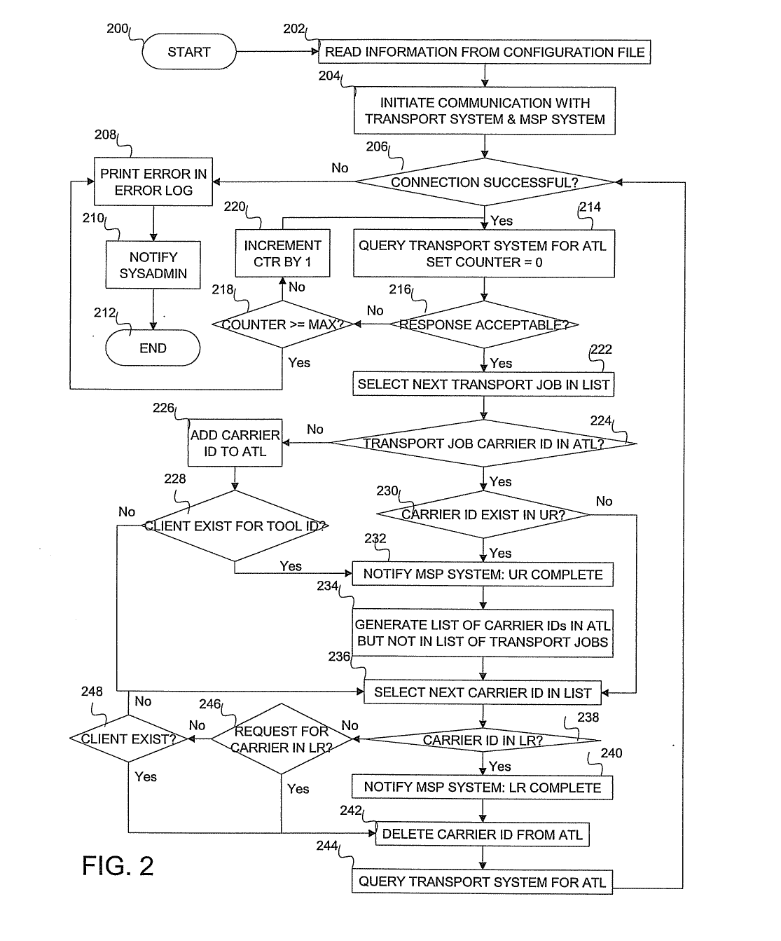

Turning now to FIG. 2, a flow diagram describing a process for implementing the E84 interface activities will now be described in exemplary embodiments. The E84 interface activities include initiating a communication with the transport system, querying the transport system for a list of active transport jobs, and inspecting a response to the querying and identifying carriers for notifying the MES of load complete and unload complete requests. The activities also include notifying the MES that identified carriers are ready for respective load and unload complete actions. Upon determining a malfunction occurrence between the MES and the transport system, the method includes using results of the querying and inspecting to provide a status of the active transport jobs, and deleting carrier IDs for the identified carriers from the list of active transport jobs in response to the notifying as will now be described in further detail.

The process starts at step 200 whereby information is read from a configuration file (e.g., from storage device 110) at step 202. The configuration file stores information, such as MaxRetry value (relating to transport system 106 queries for active transport lists), AMHS/ARHS connection details, error log file name, notification method, server socket number, etc.

At step 204, a communication with the transport system 106 and MSP system 104 is initiated. The MSP system 104 connection may be implemented by opening a server socket to accept connections from MSP simulators or equipment simulators (e.g., MSP 118). A separate process may be spawned to receive LOAD and UNLOAD requests from external applications (e.g., from the MSP 118).

At step 206, it is determined whether the connection to the MSP system 104 is successful (e.g., active communication session achieved). If not, an error message is printed in the error log (e.g., in storage device 112), a system administrator is notified of the error at step 210, and the process ends at step 212.

If, on the other hand, the connection is successful at step 206, the transport system 106 is queried for an active transport list (ATL) at step 214 and a counter that is maintained by the MSP system 104 is set to zero. At step 216, it is determined whether the response from the transport system 106 is acceptable. Acceptability criteria for responses may include, e.g., where the transport system 106 does not respond within the associated request timeout (e.g., 120 seconds); where the transport system 106 responds with a message having a return code that is not deemed valid; or where the transport system 06 responds with a message having a valid return code but the message structure is valid (e.g., using common message structure protocols).

If the response is not acceptable at step 216, it is determined whether the counter value is greater than or equal to a maximum counter value (e.g., MaxRetry) at step 218. If not, the counter is incremented by one at step 220 and the process returns to step 214. Otherwise, if the counter is greater than or equal to the maximum counter value at step 218, the process returns to step 208.

Returning now to step 216, if the response is acceptable, the next transport job in the ATL is selected at step 222. At step 224, it is determined whether the transport job carrier ID is found in the ATL. If not, the carrier ID is added to the ATL at step 226 and it is then determined whether a client exists for the tool ID at step 228. A client may be any other application (Java or C++ or any other language based) that is connected (e.g., MSP system 118). The client needs to know the hostname and the TCP/IP port number and other required connection parameters so that it can connect. The communication medium may be simple socket connections or may have a bigger implementation such as CORBA, etc. When a client connects, the system adds the client's connection ID along with the client's ID to its internal hash table.

The purpose of the hash table (e.g., a dynamic data structure that allows search by key ID, in this case client ID) is to maintain the list of connected client IDs and the corresponding client's connection ID. In the event that the system sees that there is no client connected to notify at step 228, the system ignores the notification process for the current notification record (carrier ID) and proceeds to the next carrier ID in the list (step 236).

Returning to step 228, if a client exists for the tool ID, the MSP system 104 is notified that the UNLOAD request is complete at step 232.

Returning to step 224, if the transport job carrier ID is in the ATL, it is then determined if the carrier ID exists in the UNLOAD request step 230. If a carrier ID is not found in the unload request table, the system takes no action, i.e., where it would have attempted to find a client for the carrier ID, the system will merely do nothing and proceed to the next carrier ID it sees in the unload request table at step 236. Otherwise, the MSP system 104 is notified that the UNLOAD request is complete at step 232.

A list is generated for the carrier IDs that are in the ATL but not in the list of transport jobs at step 234. This may be complementary logic that finds carriers that are in a modified transport state since the last time the ATL was changed. At step 236, the next carrier ID in the list is selected. At step 238, it is determined if the carrier ID is in the LOAD request. If so, the MSP system 104 is notified that the LOAD request is complete at step 240. The carrier ID is deleted from the ATL in step 242, and the transport system 106 is queried for the next ATL at step 244. The process then returns to step 206.

Returning to step 238, if a carrier ID is not in Load request table, it implies that either there is no client that is waiting for the carrier to complete the transport job (waiting for Load) or it may also imply that there is a connected client waiting (which has not requested a Load notification). The carrier that has been found is treated as a candidate for Load and the process attempts to find if there is a request in the Load Request table at step 246. If so, the client (e.g., MSP 118) is notified at step 240. If not, the process attempts to find if there is a connected client for the client ID referenced by the carrier ID at sep 248. If a connected client is found, the MSP system is notified at step 240. If no connected client is found at step 248, the process proceeds to the next carrier in the list at step 236.

As indicated above, when a malfunction occurs with respect to the MES or MES interface, the MSP interface 120 provides a status of all active transport jobs that have been tracked via the aforementioned process of FIG. 2.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing a program interface for communications between a manufacturing execution system (MES) and a transport system, comprising:
initiating a communication with the transport system;
querying the transport system for a list of active transport jobs;
inspecting response to the querying and identifying carriers for notifying the MES of load complete and unload complete requests;
notifying the MES that identified carriers are ready for respective load and unload complete actions;
upon determining a malfunction occurrence between the MES and the transport system, using results of the querying and inspecting to provide a status of the active transport jobs; and
deleting carrier IDs for the identified carriers from the list of active transport jobs in response to the notifying.

2. The method of claim 1, further comprising:
determining whether the response is acceptable and if the response is not acceptable:
incrementing a counter by one;
querying the transport system for the list of active transport jobs; and
repeating the determining, incrementing, and querying until at least one of:
a maximum value specified for the counter has been reached; and
the response is determined to be acceptable.

3. The method of claim 1, further comprising:
retrieving a configuration file from a storage device, the configuration file storing data including:
a counter value;
transport system connection details;
error log file name;
MES notification method; and
server socket number;
wherein the initiating a communication with the transport system is implemented in response to the data in the configuration file.

4. A system for providing a program interface for communications between a manufacturing execution system (MES) and a transport system, comprising:
a machine supervisory program interface executing on the MES, the machine supervisory program interface implementing a method, the method comprising:
initiating a communication with the transport system;
querying the transport system for a list of active transport jobs;
inspecting response to the querying and identifying carriers for notifying the MES of load complete and unload complete requests;
notifying the MES that identified carriers are ready for respective load and unload complete actions;
upon determining a malfunction occurrence between the MES and the transport system, using results of the querying and inspecting to provide a status of the active transport jobs; and
deleting carrier IDs for the identified carriers from the list of active transport jobs in response to the notifying.

5. The system of claim 4, wherein the machine supervisory program interface further performs:
determining whether the response is acceptable and if the response is not acceptable:
incrementing a counter by one;
querying the transport system for the list of active transport jobs; and
repeating the determining, incrementing, and querying until at least one of:
a maximum value specified for the counter has been reached; and
the response is determined to be acceptable.

6. The system of claim 4, wherein the machine supervisory program interface further performs:
retrieving a configuration file from a storage device, the configuration file storing data including:
a counter value;
transport system connection details;
error log file name;
MES notification method; and
server socket number;
wherein the initiating a communication with the transport system is implemented in response to the data in the configuration file.

7. A computer program product for providing a program interface for communications between a manufacturing execution system (MES) and a transport system, the computer program product including instructions for causing a computer to implement a method, comprising:
initiating a communication with the transport system;
querying the transport system for a list of active transport jobs;
inspecting response to the querying and identifying carriers for notifying the MES of load complete and unload complete requests;
notifying the MES that identified carriers are ready for respective load and unload complete actions;
upon determining a malfunction occurrence between the MES and the transport system, using results of the querying and inspecting to provide a status of the active transport jobs; and
deleting carrier IDs for the identified carriers from the list of active transport jobs in response to the notifying.

8. The computer program product of claim 7, further comprising instructions for implementing:
determining whether the response is acceptable and if the response is not acceptable:
incrementing a counter by one;
querying the transport system for the list of active transport jobs; and
repeating the determining, incrementing, and querying until at least one of:
a maximum value specified for the counter has been reached; and
the response is determined to be acceptable.

9. The computer program product of claim 7, further comprising instructions for implementing:
retrieving a configuration file from a storage device, the configuration file storing data including:
a counter value;
transport system connection details;
error log file name;
MES notification method; and
server socket number;
wherein the initiating a communication with the transport system is implemented in response to the data in the configuration file.
